(19) United States
(12) Patent Application Publication
(10) Pub. No.: US 2010/0202822 A1
(43) Pub. Date: Aug. 12, 2010

(54) SYSTEMS, METHODS AND APPARATUSES FOR PROVIDING BODY-SHAPED PENHOLDERS

(76) Inventor: Gregg Smith, New York, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/704,055

(22) Filed: Feb. 11, 2010

Related U.S. Application Data
(60) Provisional application No. 61/151,633, filed on Feb. 11, 2009.

(51) Int. Cl. B43K 29/00; F16M 13/00

(52) U.S. Cl. 401/195; 248/511

(57) ABSTRACT

This relates to body-shaped penholders. In some embodiments, the penholder can be shaped like a body by, for example, including appendages such as arms and legs. In some embodiments, body parts such as, for example, tails, wings or any other suitable body parts can be included on the penholder. In some embodiments, accessories, clothing, props, faces or any other suitable enhancements can be combined with the penholder. A pen can then be decoratively and enjoyably stored in the penholder. In this manner, the penholder can favorably increase a person's fun and enjoyment by allowing a person to, for example, interact with, play with, or create a collection of the penholders. In addition, the penholder can add further functionality to a pen by converting the pen from a mere writing tool into a toy. This may favorably encourage a child to, for example, complete their school work or write creative stories.

### CROSS-REFERENCE TO RELATED APPLICATIONS

This application claims the benefit of U.S. Provisional Patent Application No. 61/151,633, filed on Feb. 11, 2009, which is hereby incorporated by reference herein in its entirety.

### FIELD OF THE INVENTION

This relates to systems, methods and apparatuses for providing penholders. In particular, this relates to systems, methods and apparatuses for providing body-shaped penholders.

### BACKGROUND OF THE INVENTION

Pens are well-known, practical tools that are commonly used by people on a daily basis. Oftentimes, pens can be stored in various “penholders” that are generally cup-shaped and functional in nature.

### SUMMARY OF THE INVENTION

Systems, methods and apparatuses for providing a body-shaped penholder are provided. In some embodiments, the penholder can be shaped like a body by, for example, including appendages such as arms and legs. In some embodiments, the arms, legs or both can include magnets or other ways of coupling multiple penholders together. For example, two penholders can “hold hands” by coupling a hand from one penholder to a hand of the other penholder, where a magnet can be affixed to each of those hands. In this instance, the magnets would need to be of opposite polarity (or the hands would repel each other). In some embodiments, the body can include body parts such as an animal tail, hooves, wings, horns or any other suitable body parts.

In some embodiments, accessories, clothing, props or any other suitable enhancements can be combined with the penholder. For example, items such as pants, skirts, jackets, shirts, shoes, gloves, jewelry, purses, backpack, swords, hats, headbands, skateboards or surfboards can be combined with the penholders. In some embodiments, faces can be affixed to the penholder, pen or both.

A body-shaped penholder can add further functionality and benefits to a pen that is used with the body-shaped penholder. For example, utilizing the body-shaped penholder can convert a pen from being merely a writing tool into a toy. This may increase the enjoyment and satisfaction a person gains from the pen. For example, the penholder may help encourage children to do their school work, foster creativity in writing stories, or transform writing and work into an enjoyable and fun experience.

In some embodiments, the penholder can add further functionality by being used with a game board to create a game. For example, a penholder can function as a “game piece” that a player can move across the game board by, for example, rolling dice, spinning a wheel or answering questions correctly. In some embodiments, magnets coupled to the penholder can interact with magnets coupled to the game board to hold the penholders to the game board (or, alternatively, to repel the penholders from portions of the game board). In some embodiments, the addition of a pen or accessories to the penholder can signify that a particular goal in the game has been achieved. For example, when a penholder moves to a portion of the board labeled “magic abilities,” an accessory shaped like a magic wand can be coupled to the penholder's hand.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIGS. 1-4 show illustrative penholders in accordance with some embodiments of the present invention;

FIGS. 5A-5B show illustrative penholders and clothing in accordance with some embodiments of the present invention;

FIGS. 6A-6B show illustrative penholders in accordance with some embodiments of the present invention;

FIGS. 7A-7D show illustrative penholders and accessories in accordance with some embodiments of the present invention;

FIGS. 8A-8C show illustrative penholders and faces in accordance with some embodiments of the present invention; and

FIG. 9 shows an illustrative game board and penholders in accordance with some embodiments of the present invention.

### DETAILED DESCRIPTION OF THE INVENTION

This relates to body-shaped penholders. In some embodiments, the penholder can be shaped like a body by, for example, including appendages such as arms and legs. Accessories, clothing, props, faces or any other suitable enhancements can be combined with the penholder. A pen can then be decoratively and enjoyably stored in the penholder. In this manner, the penholder can favorably increase a person's fun and enjoyment by allowing a person to, for example, interact with, play with, or create a collection of the penholders. In addition, utilizing a pen with the body-shaped penholder can transform the pen from merely being a functional writing instrument into an enjoyable toy. This may inspire, for example, children to do their school work, write reports, or may favorably foster creativity and inspiration when writing stories or other papers.

As used herein, the term “pen” can include any suitable writing instrument such as, for example, pens, pencils, markers, crayons, highlighters, chalk or any other writing instrument. The term “pen” is used throughout the disclosure for simplicity and clarity, but one skilled in the art could appreciate that any suitable writing instrument could alternatively be used without departing from the scope of the invention.

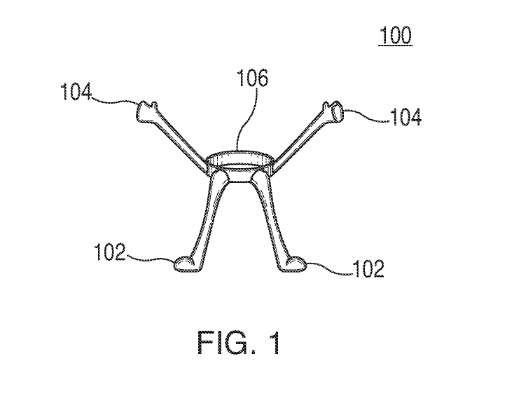

In some embodiments, the main body of the penholder can be created from a band of material that can fit around a pen. For example, FIG. 1 shows an illustrative penholder 100 that can include legs 102, arms 104 and waist band 106. Waist band 106 can be created from any suitable loop of stretchy material, such as, for example, a rubber band, an elastic band or a loop of flexible plastic. A pen can be inserted through the center of waist band 106, which can then securely hold legs 102 and arms 104 to the pen. Once inserted, the pen can become a life-like character to a child.

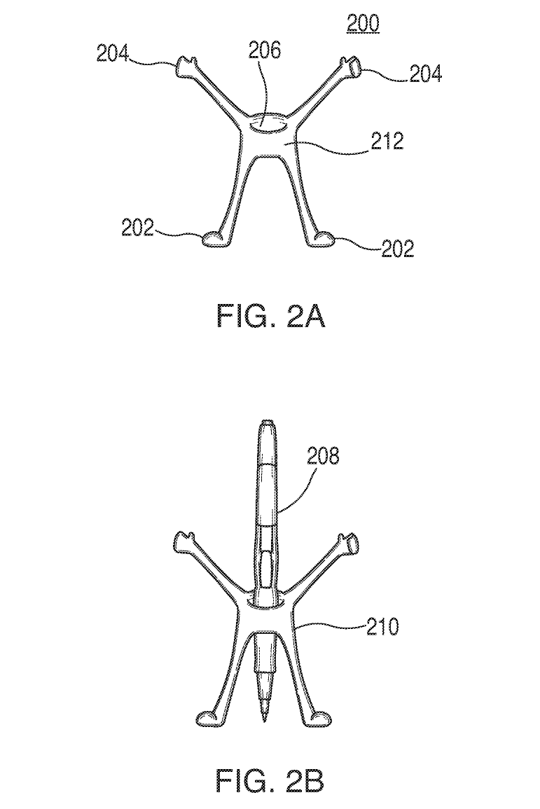

As another example, FIG. 2A shows penholder 200 that is accordance with some embodiments of the present invention. Penholder 200 can include legs 202, arms 204, and waist hole 206. Waist hole 206 can extend through penholder 200 and, by placing a pen through waist hole 206, can be used to hold that pen. For example, FIG. 2B shows pen 208 after being inserted into penholder 210. The penholder may then, for example, be placed on a desk, shelf, counter, or any other suitable surface, to decoratively and enjoyably hold the pen.

The material 212 of penholder 200 surrounding waist hole 206 can be formed from any suitable material for holding a pen. For example, material 212 can be formed from rubber, foam, plastic, metal, or any other suitable material. In some embodiments, material 212 can be a flexible material (e.g., rubber, or foam) that can allow waist hole 206 to stretch around pens of varying diameters. This can allow penholder 200 to hold a variety of pens of different shapes and sizes. In some embodiments, to facilitate penholder 200 in holdings pens of various shapes and sizes, waist hole 206 can be tapered by having a wider diameter at the top than at the bottom of waist hole 206. Legs 202 and arms 204 can be created from a different material than or from the same material as the material surrounding waist hole 206. Designs, shapes and materials for creating legs 202 and arms 204 will be discussed in greater detail in the descriptions and figures that follow.

The penholder can be created from any suitable color (e.g., red, green, blue or violet). In some embodiments, the penholder can be colored with one or more patterns (e.g., striped, spotted or checkered). In some embodiments, the material of the penholder can have sparkles or other visual objects mixed into the material. In some embodiments, the penholder can have a light source such as, for example, a light emitting diode (“LED”) or an organic LED (“OLED”), coupled onto the surface or in the material of the penholder. In this scenario, a power source may be available to supply power to the light source. For example, in some embodiments a battery can be used to power the light source. Alternatively or additionally, the penholder can have the ability to be coupled to an external power source such as, for example, a power outlet.

In some embodiments, the penholder can have a compartment or other structure for storing items. For example, the penholder can have a compartment for storing items such as coins, jewelry, paper clips, erasers, or candy.

In some embodiments, the design of the penholder can be a simplified, general design (e.g., a basic body with simple arms and legs extending from the body). Having a simplified, general design for the penholder can create a consistent look that is easily recognizable by users. As another example, a generic design can allow users to readily interchange multiple penholders with various pens and penholder accessories. As yet another example, a general design can allow a variety of penholders to be created from a single mold. For example, a single mold can be used and, by varying the materials or colors used in that mold, a wide variety of penholders can be created. Using a single mold to create a variety of penholders can be a cost effective and desirable way of making the penholders.

In some embodiments, the arms and legs of the penholder (e.g., legs 202 and arms 204 of FIG. 2A), can be created from a rigid, non-flexible material that is not readily bent. This can help the penholder stay upright on a surface when a pen has been inserted into the penholder. In some embodiments, the arms and legs can be created from a material that can be bent and that, after bending, maintains its bent position. For example, the arms can be formed from a material that includes a thin, metal plate or a flexible, but stiff, plastic. This can allow a user to attach two penholders together by bending the hands of the two penholders together, thus having the two penholders “hold hands.”

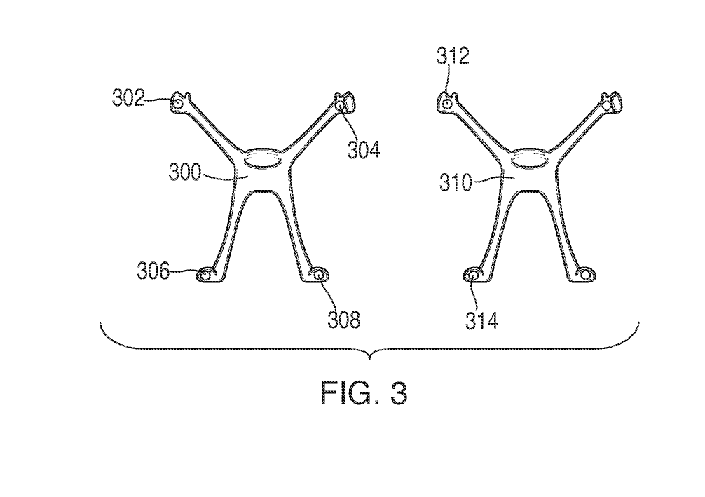

In some embodiments, magnets can be coupled to the arms, legs, or both of the penholder. For example, FIG. 3 illustrates penholder 300 that can have right magnet 302 and left magnet 304 coupled to the palms of the respective hands of penholder 300. Similarly, right magnet 306 and left magnet 308 can be coupled to the respective feet of penholder 300. Penholder 300 can then be coupled to a different penholder through these magnets. For example, penholder 300 and penholder 310 can “hold hands” by coupling left magnet 304 with right magnet 312 that is attached to the right palm of penholder 310. Similarly, penholder 300 and penholder 310 can be coupled through left magnet 308 and right magnet 314 that are attached to the feet of the penholders.

In order for the two magnets of different penholders to couple together, the magnets should be of different polarities. If the magnets are of the same polarity, then the two magnets (e.g., the two hands) would repel each other rather than coupling together. Accordingly, in some embodiments, magnets on the left hands of each penholder can be a certain polarity (e.g., a positive polarity) and the magnets on the right hands of each penholder can be the opposite polarity (e.g., a negative polarity). Similarly, the magnets on the left feet and the magnets on the right feet of each penholder can be of opposite polarities. This can ensure that the right hand and the left hand (or the right foot and the left foot) of two different penholders can be coupled together through the magnets.

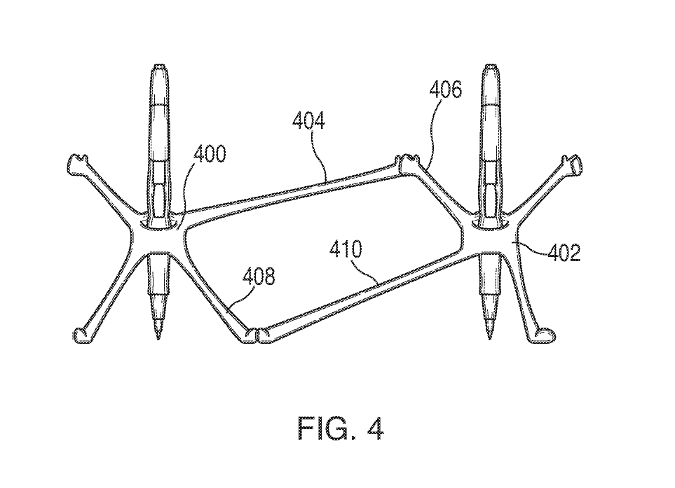

In some embodiments, the arms and legs of the penholders can be formed from a stretchy material (e.g., a rubber or flexible plastic). The arms and legs of various penholders can then be stretched and coupled to one another (e.g., coupled by magnets or by a stiff material that, after being bent, maintains its position). For example, FIG. 4 shows penholder 400 and penholder 402 as having arms and legs formed from stretchy material.

For example, arm 404 of penholder 400 and arm 406 of penholder 402 can each be stretched and attached to one another. Similarly, leg 408 of penholder 400 and leg 410 of penholder 402 can each be stretched and attached to one another. In some embodiments, the arms and legs of the penholders can be formed from a soft or limp material such as, for example, string or cloth.

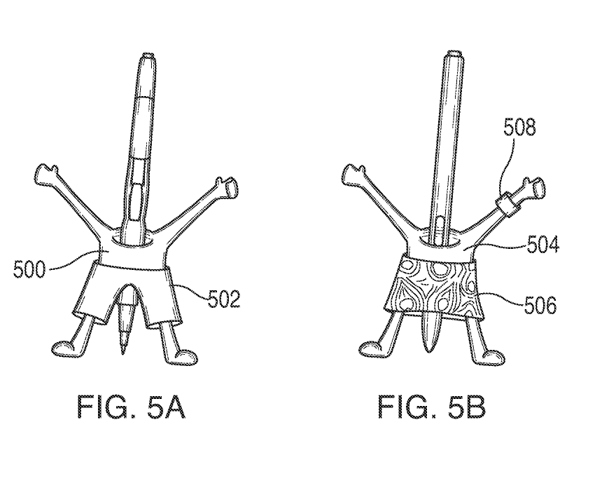

In some embodiments, the penholders can be dressed with clothing or other suitable decorations. In some embodiments, the clothing can be gender-specific. For example, FIG. 5A illustrates boy penholder 500 with clothing that can include shorts 502. Similarly, FIG. 5B illustrates girl penholder 504 with clothing that can include skirt 506. As another example of gender-specific clothing, girl penholder 504 can include clothing such as bracelet 508.

In some embodiments, the clothing and the penholder can be formed from a single piece of material. For example, boy penholder 500 and shorts 502 can both be created from a single piece of material (e.g., from a material such as rubber). In this scenario, since the clothing and the bodies are formed from a single piece of material, a different mold can be used to form boy penholder 500 than the mold used to form girl penholder 504.

As mentioned above, in some embodiments it can be beneficial to create the penholders from a single mold (e.g., as opposed to one mold that can form a girl penholder with a skirt and a different mold that can form a boy penholder with shorts). Thus, in some embodiments, the clothing for the penholders (e.g., shorts 502 or skirt 506) can be created as items that are separate from the penholder and that can be removed from and interchanged among various penholders. This can allow a girl penholder and a boy penholder to be created from the same mold (e.g., and the gender may be determined by what clothing is added to the penholder to “dress” them). Furthermore, this can create additional enjoyment and fun for a user by allowing the user to collect and buy various clothing outfits for their penholders and then dress up and play with their penholders. The penholder clothing can be created from any suitable material, such as, for example cloth, plastic or rubber.

The penholders can be dressed with any suitable piece of clothing. For example, the penholders can be dressed with skirts, shorts, pants, bathing suits, shirts, jackets, dresses, socks, shoes, roller skates, gloves or any other suitable piece of clothing. In some embodiments, hand or feet clothing (e.g., gloves or shoes) can include holes to allow magnets on the hands or feet to protrude through the clothing. In some embodiments, clothing with pants legs (e.g., shorts or pants) can be stitched for only a lower portion of the inner leg, thus allowing the piece of clothing to be readily put on and taken off the penholder. In some embodiments, the clothing can include a suitable means of holding the clothing on the penholder such as, for example, an elastic waist band, magnets, Velcro™, a belt or an adhesive material.

The clothing for the penholders can be decorated with any suitable design or color. In some embodiments, “reversible” clothing can be used. The reversible clothing can be turned inside-out to reveal a different pattern on the reverse side of the clothing. In this manner, the reversible clothing can function as two pieces of clothing. In some embodiments, the clothing can be designed with a known insignia or corporate logo, such as, for example, a sports team logo, a television show logo, a brand logo, the name of a famous person or a company logo.

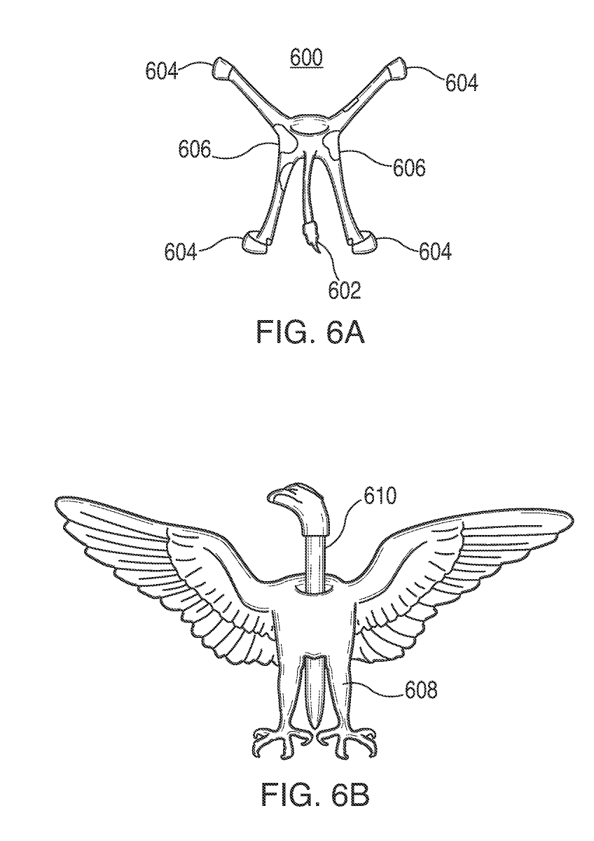

In some embodiments, the penholder can be designed in other body shapes such as, for example, animal body shapes, alien body shapes or comic character body shapes. As another example, the penholder can be formed with animal body parts such as tails, hooves, wings, bird feet, antenna, horns or any other suitable body part. For example, FIG. 6A shows penholder 600 that can be formed with tail 602 and hooves 604. In some embodiments, the penholder can be colored with a particular design or color that complements the animal body parts or can mimic a particular animal. For example, penholder 600 can be designed to look like a cow and can accordingly be colored with cow spots 606.

In some embodiments, the penholder can be used to hold a pen that is designed to match the particular body shape or animal body parts of the penholder. For example, FIG. 6B shows penholder 608 that can be designed to look like a bird. Penholder 608 can then be used to hold pen 610 that can include a bird-shaped head on the top of the pen. By combining penholder 608 with pen 610, a full “toy bird” can be produced that a user can enjoy or play with. In some embodiments, a user can collect various penholders of different body shapes or colors and mix-and-match these penholders with different types of pens. For example, a person can create new animals or creatures by combining one body shape (e.g., a penholder with a dog body-shape) with different pens (e.g., a pen with a bird head).

In some embodiments, any suitable accessory or enhancement can be combined with the penholder. For example, an accessory can be attached to and then removed from a penholder. This can allow a user to collect various penholders and accessories, and then decorate and redecorate the penholders with various combinations of these accessories.

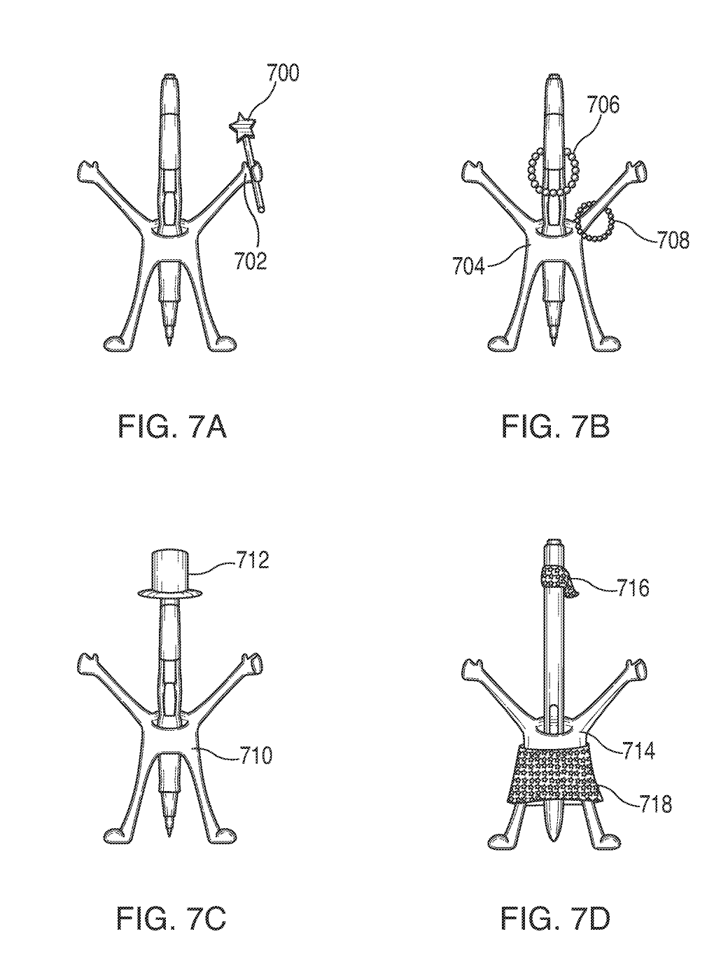

As one example, FIG. 7A illustrates an accessory 700 that can be held in hand 702 of a penholder. Accessory 700 can be, for example, a sword, a leash for a pet, an umbrella, a magic wand, a pen, a flower, a letter, a radio, an iPod™, a book, lipstick, a drink or any other suitable accessory. Accessory 700 can be attached to hand 702 through any suitable means such as, for example, magnets, Velcro™, elastics, or an adhesive material. For example, accessory 700 can include a magnet, and can be coupled to magnet that is attached to hand 702, such as, for example, magnet 304 of FIG. 3.

As another example, the penholder can include an accessory that can be used as a prop or on which the penholder can stand. For example, the penholder can include props such as a surfboard, a beach blanket, or a skateboard. As another example, the penholder can include accessories that can be hung over or wrapped around the penholder, the pen, or both. For example, FIG. 7B illustrates penholder 704 that can include necklace 706, bracelet 708, or both. As another example, FIG. 7C illustrates penholder 710 that can include hat 712. As yet another example, FIG. 7D illustrates penholder 714 that can include bandana 716. In some embodiments, the accessories can be designed to coordinate with other accessories, with other clothing, or both. For example, the design of bandana 716 can coordinate with the design of skirt 718. Other examples of accessories can include jewelry, wrist bands, watches, purses, backpacks, bags, hats (e.g., top hats, fireman hats, baseball caps or cowboy hats), glasses, headbands or any other suitable accessory.

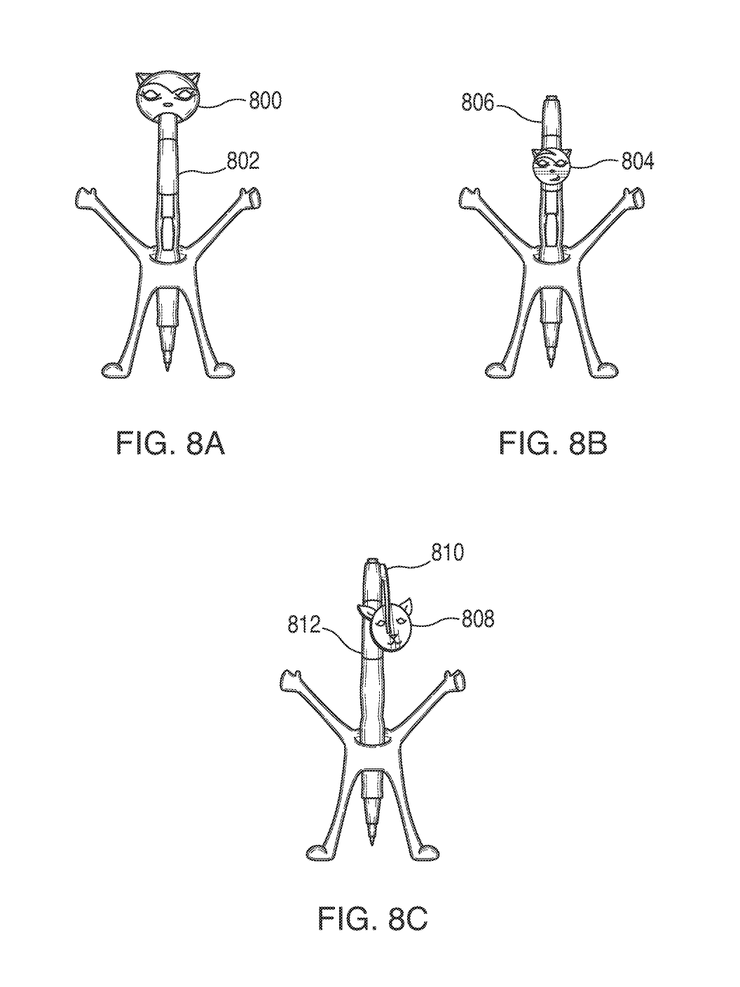

In some embodiments, the penholders, pens or both can be decorated with various faces. The faces can include any suitable persona, such as, for example, a cartoon face, an animal face, an alien face or a known person or character (e.g., Sponge Bob Square Pants™, Care Bears™ characters, or former President George Bush). In some embodiments, the face can be created using a “head cap” that can be placed over the top of a pen. For example, FIG. 8A shows head cap 800 that can be placed over a pen, such as pen 802. Head cap 800 can be formed from any suitable material such as, for example, rubber, plastic, metal, foam, or cloth. In some embodiments, head cap 800 can be formed from a semi-elastic material that can be stretched over the top of a pen, thus causing head cap 800 be securely held in place.

In some embodiments, the face can have an adhesive or other sticky material applied to one side of the face. The face can then be coupled to a pen through the adhesive (or other sticky material). For example, FIG. 8B shows face 804 that can be coupled to pen 806 through an adhesive. Preferably, the adhesive can be created from a material that can allow face 804 to be removed and then reapplied to pens and other surfaces multiple times without losing its adhesive qualities.

In some embodiments, a face can be coupled to a pen by slipping the face under a pen clip. For example, FIG. 8C shows face 808 that can be slipped under pen clip 810 to be held against pen 812. In such embodiments, face 808 may also include a fastener or other attachment device (not shown) that can help to hold face 808 in place against clip 810. In some embodiments, pen clip 810 can be included on a pen cap that can be removed from pen 812. In other embodiments pen clip 810 can be attached directly to pen 812.

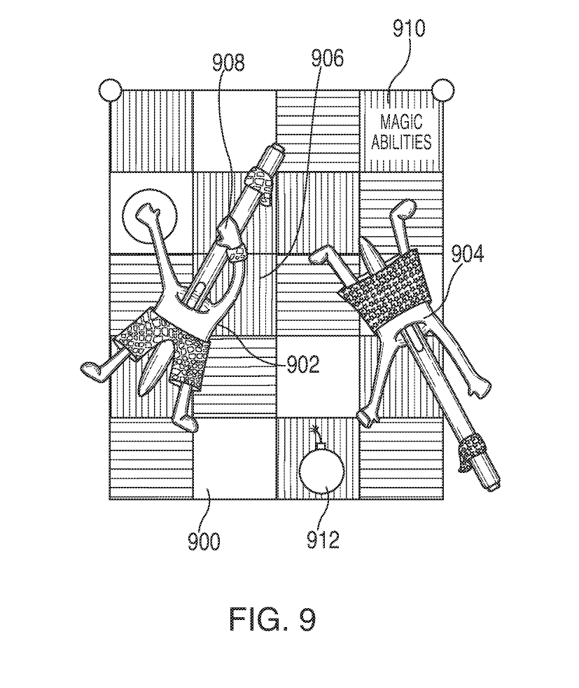

In some embodiments, the penholders can be designed so that they can be used with a game board or other props to create a game. For example, FIG. 9 shows game board 900 that can be used to play games with one or more penholders such as, for example, penholder 902 and penholder 904. In some embodiments, game board 900 can placed on the floor, hung on a wall, or both. In some embodiments, the penholders can progress across game board 900 when, for example, a player rolls dice, spins a wheel, or answers questions correctly.

In some embodiments, magnets coupled to the penholder (e.g., such as those magnets described above with respect to FIG. 3) can interact with magnets coupled to the game board to hold the penholders to the game board or to repel the penholder from the game board. As one example, the penholders can be thrown against and then held to game board 900. As another example, the magnets on the penholders can interact with magnets coupled to the game board to repel the penholders from at least a portion of the board. For example, square 906 of game board 900 may include magnets of a polarity that repel the magnet in hand 908, thus preventing penholder 902 from progressing to square 906.

In some embodiments, the addition of a pen or accessories to the penholder can signify that a particular goal in the game has been achieved. For example, when a penholder moves to square 910 labeled “magic abilities,” an accessory shaped like a magic wand can be coupled to the penholder's hand. As another example, when a penholder reaches a particular goal or square on game board 900, a pen can be placed into the penholder.

In some embodiments, the game board can have various obstacles that a player can dodge with their penholder. For example, game board 900 shows obstacles such as bomb 912 that a player can dodge as their penholder progresses across game board 900.

The above described embodiments of the present invention are presented for purposes of illustration and not of limitation, and the present invention is limited only by the claims which follow.

What is claimed is:

1. A body-shaped penholder, the penholder comprising:
a main body;
a hole extending vertically through the main body, wherein the hole and main body are operable to hold a writing instrument; and
at least one appendage coupled to the main body.

2. The penholder of claim 1, further comprising:
at least one magnet, wherein the at least one magnet is coupled the at least one appendage.

3. The penholder of claim 1, further comprising:
at least one animal body part.

4. The penholder of claim 1, wherein:
the main body comprises a flexible material; and
the hole is further operable to hold a writing instrument of variable size.

5. The penholder of claim 1, wherein:
the hole is tapered and comprises a larger diameter at one end of hole than at the other end of the hole.

6. The penholder of claim 1, wherein the penholder is formed to give the appearance of a particular gender.

7. The penholder of claim 1, further comprising:
accessories operable to be coupled to the penholder.

8. The penholder of claim 1, further comprising:
clothing operable to be coupled to the penholder.

9. A system, the system comprising:
a writing instrument; and
a penholder, wherein the penholder comprises;
a main body;
two arms, wherein each arm is coupled to the main body;
two legs, wherein each leg is coupled to the main body; and
a hole extending vertically through the main body, wherein the hole is operable to hold the writing instrument.

10. The system of claim 9, further comprising:
a face, wherein the face is coupled to the writing instrument.

11. The system of claim 9, further comprising:
clothing, wherein the clothing is operable to clothe one or more of the writing instrument and the penholder.

12. The system of claim 9, further comprising:
at least one accessory, wherein the at least one accessory is operable to decorate one or more of the writing instrument and the penholder.

13. The system of claim 9, wherein:
the penholder comprises a body shape of a particular animal; and
the writing instrument comprises a head, wherein the head is shaped like a head of the particular animal.

14. The system of claim 9, further comprising:
two hands, wherein each hand is coupled to a separate one of the arms;
two feet, wherein each foot is coupled to a separate one of the legs; and
one or more magnets, wherein the one or more magnets are coupled to at least one of the hands or feet.

15. The system of claim 9, further comprising:
a game board, and wherein:
the penholder is operable to be used as a game piece on the game board.
